(19) United States
(12) Patent Application Publication
(10) Pub. No.: US 2010/0215441 A1
(43) Pub. Date: Aug. 26, 2010

(54) Reinforced Mass of Material and Method of Forming

(75) Inventor: Hamid Saadatmanesh, Tucson, AZ (US)

Correspondence Address: QUARLES & BRADY LLP, ONE SOUTH CHURCH AVENUE, SUITE 1700, TUCSON, AZ, 85701-1621, US

(73) Assignee: Regents on behalf of the University of Arizona

(21) Appl. No.: 12/523,043

(22) PCT Filed: Jan. 12, 2007
(86) PCT No.: PCT/US07/60514

§ 371 Date: May 3, 2010

(51) Int. Cl. C09K 17/04; B32B 9/00

(52) U.S. Cl. 405/266

(57) ABSTRACT

A new and useful concept for reinforcing a mass of material is provided, particularly for reinforcing a mass of material that may be used to form a dam or comparable structure (FIG. 1). A reinforced material mass according to the present invention comprises a mass of material taken from a class that includes earthen material, soil, rock, and combinations thereof, and has a lining forming a part thereof, the lining comprising a woven fabric saturated with a resin that has a flexibility of at least 3-6% elongation at break. The lining forms a substantially impervious lining to a mass of material that forms a dam or comparable structure. Additionally, the lining reinforces the mass of material against the types of hydraulic and other pressures that may be applied to a dam or comparable structure. Moreover, since such a mass of material may have irregularities in shape when the mass of material is initially formed, or may have a shape that may change with time or under the environmental conditions to which the mass of material is exposed, the flexibility of the lining is enables the lining to conform to irregularities in the shape of the mass of material, and also enables the lining to conform (at least to some degree) to shifts in the configuration of the mass of material due to time, or the environmental conditions to which the mass of material is exposed. In addition, in a preferred embodiment, the lining includes silica particles in the resin to create friction between the lining and the mass of material.

### BACKGROUND AND SUMMARY OF INVENTION

The present invention relates to a new and useful concept for reinforcing a mass of material of the type that may be used to form a dam or comparable structure. A reinforced material mass according to the present invention comprises a mass of material taken from a class that includes earthen material, soil, rock, and combinations thereof, and has a lining forming a part thereof, the lining comprising a fabric (preferably woven fabric) saturated with a resin that has a flexibility of at least 3-6% elongation at break.

The lining forms a substantially impervious lining to a mass of material that forms a dam or comparable structure. Additionally, the lining reinforces the mass of material against the types of hydraulic and other pressures that may be applied to a dam or comparable structure (for example, the weight of the material forming the dame or other structure). Also, the lining provides tensile strength that resists fissures and cracks and prevents sudden failure of the dam. Moreover, since such a mass of material may have irregularities in shape when the mass of material is initially formed, or may have a shape that may change with time or under the environmental conditions to which the mass of material is exposed, the lining is preferably flexible, to enable the lining to conform to irregularities in the shape of the mass of material, and also enables the lining to conform (at least to some degree) to shifts in the configuration of the mass of material due to time, or the environmental conditions to which the mass of material is exposed.

According to the present invention, the lining may be embedded in the mass of material (e.g. by trenches formed in the mass of material), or the flexible lining may be disposed against a side of the mass of material.

In addition, in a preferred embodiment, the lining includes silica or other particles in the resin to create friction between the lining and the mass of material.

Other features of the present invention will become further apparent from the following detailed description and the accompanying drawings.

### BRIEF DESCRIPTION OF THE DRAWINGS

FIG. 1 is a schematic illustration of a dam formed with a lining disposed along a side of the dam, according to the principles of the present invention;

FIG. 2 is a schematic illustration of a dam formed with a lining embedded in the mass of material forming the dam, according to the principals of the present invention;

FIG. 3 is a schematic illustration of a dam with a lining embedded in the dam, in a different configuration than the lining of the dam of FIG. 2, and also schematically illustrating how the lining affects flow (or seepage) of water through the dam;

FIGS. 4a and 4b are schematic illustrations of exemplary fabric patterns that can be used in forming a lining, according to the principles of the present invention;

FIG. 5 is a schematic, cross sectional view of a hillside, and schematically illustrates the use of a lining for stabilizing a slope (e.g. of a mining environment, a landfill, a mountainside, etc.), according to the principles of the present invention; and

FIG. 6 is a schematic, cross sectional view of a mechanically stabilized earth (MSE) wall, and schematically illustrates mechanically stabilized earth (MSE) walls, with a stabilizing lining according to the principles of the present invention.

### DETAILED DESCRIPTION

As discussed above, the present invention relates to a new and useful concept for reinforcing a mass of material of the type that may be used to form a dam or comparable structure. The principles of the invention are described herein in connection with a material mass that may be used in the formation of a dam (e.g. an earth filled dam). From that description, the manner in which the principles of the present invention can be used with a material mass for other applications will be apparent to those in the art.

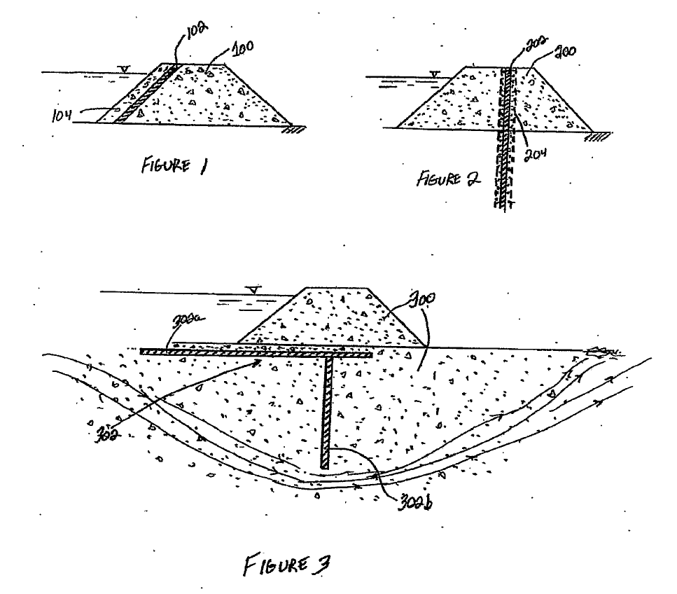

FIGS. 1 and 2 show two ways the principles of the present invention may be used with a material mass that forms a dam (e.g. an earth filled dam). In FIG. 1, a material mass 100 is formed (e.g. of earthen material) in the shape of a dam, and a lining 102 is disposed against a side of the material mass, according to the principles of the present invention. In FIG. 1, the lining 102 is laid against a side of the material mass 100, and then a covering 104 (e.g. of earth, concrete, or other covering material) is applied on top of the lining, to stabilize the lining. In FIG. 2, a material mass 200 is also formed in the shape of a dam, and a lining 202 is embedded in the mass of material 200, also according to the principles of the present invention. In FIG. 2, a trench 204 can formed (e.g. dug) in the mass of material, and the lining 202 inserted into the trench (and the trench is then backfilled).

In each of FIGS. 1 and 2, the basic shape of the dam, the materials that form the mass of material (e.g. earthen materials, soil, rock, and combinations of the foregoing) are selected according to known principles in the formation of a dam, and will be apparent to those in the art. Moreover, features such as the foundation of the dam, the compaction of the mass of material, would also be provided according to known principles in the formation of a dam. The lining (102, 202) that forms a part of the mass of material forms an impervious lining for the mass of material, and also provides a reinforcement for the mass of material. The lining comprising a woven fabric saturated with a resin that has a flexibility of at least 3-6% elongation at break. The resin can be, e.g. a polyester, vinylester, or epoxy, with a flexibility of at least 3-6% elongation at break.

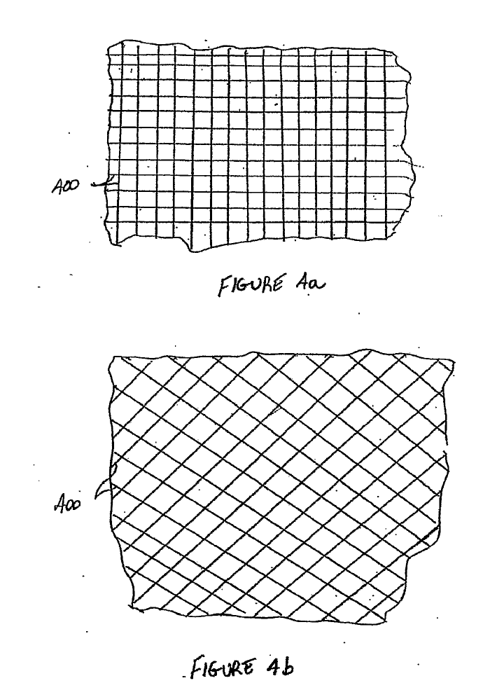

FIG. 3 further illustrates the manner in which a lining can be provided in a mass of material 300 forming a dam. In FIG. 3, the lining 302 has a horizontal section 302a and a vertically downward extending section 302b. Those sections are effectively embedded in the mass of material forming the dam. Moreover, although not shown in FIG. 3, a lining can also be applied to a side of the mass of material 300, in the manner shown in FIG. 1. As schematically shown in FIG. 3, the lining sections 302a, 302b, are impervious to water controlled by the dam, so that any water seepage must work its way around those lining sections.

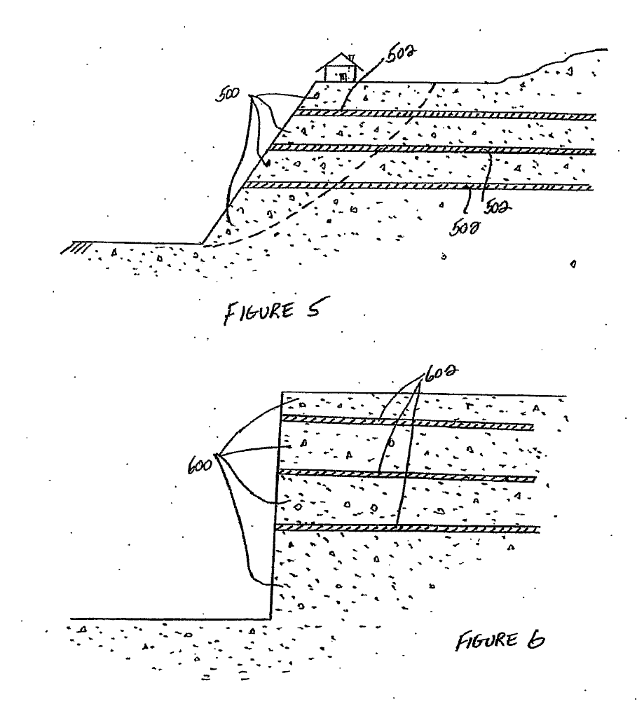

The woven fabric that forms any of the linings 102 or 202 or 302a, 303b preferably has a bidirectional fiber pattern, as shown, e.g. in FIGS. 4a, 4b. Specifically, the fabric is preferably formed from fibers 400 that are carbon fibers, or from a combination of carbon and glass or other similar fibers. The fibers 400 are preferably in a bi directional pattern characterized by (i) a first orientation of fibers that extend generally parallel to each other, and (ii) a second orientation of fibers that extend transverse to the first orientation of fibers. While the first and second orientations of fibers are preferably at about 90 degrees to each other (FIG. 4a), in this application, reference to one fiber being oriented “transverse” to another fiber is intended to mean that the one fiber is not oriented parallel to the other fiber, but either crosses the other fiber, or is oriented such that projections of the fibers would cross each other (as shown in each of FIGS. 4a and 4b). Thus, the fibers do not have to extend in horizontal and vertical rows, as illustrated, but rather can be in different patterns.

When the fabric is formed of carbon and glass fibers, the locations of the carbon and glass fibers in the first and second orientation of fibers may be selected based on the strength and flexibility desired for the fabric. When maximum fabric strength and durability is needed, the fibers would preferably be all carbon fibers.

The fabric can be initially formed (i.e. woven) and then saturated (on one or both sides) with epoxy. During such fabrication a light sand coating can be placed on one or both sides of the epoxy-coated fabric. The epoxy saturated fabric lining can be delivered to a site, e.g. in rolls of 100 ft lengths and 20 ft widths, or other desired dimensions. However, it is also contemplated that the fabric may be saturated with epoxy (and/or coated with sand) at the site, and then applied to the mass of material. Moreover, it is contemplated that the fabric can be laid on the mass of material in a dry state (with sections of the fabric overlaid slightly), optionally with stitching, hot welds, clamps or other comparable fastening means holding the fabric sections together, and the epoxy sprayed or otherwise applied onto the fabric. The epoxy saturated fabric, when used with a dam, in the manner described herein, provides tensile reinforcement to resist cracks and fissures and sudden failures. Moreover, and as illustrated in FIG. 3, the epoxy saturated fabric also provides a way of controlling water seepage about the dam.

In many applications, a single layer of the fabric, saturated with the epoxy will be sufficient in the mass of material. For some applications, a heavier fabric and/or multiple layers of fabric may be desirable.

In the dams of FIGS. 1, 2 and 3, the lining forms a substantially impervious lining to the mass of material that forms the dam. The flexible lining reinforces the mass of material against the types of hydrostatic and other pressures that may be applied to a dam. Moreover, since a mass of material that forms a dam may have irregularities in shape when the mass of material is initially formed, or may have a shape that may change with time or under the environmental conditions to which the mass of material is exposed, the flexibility of the lining enables the lining to conform to irregularities in the shape of the mass of material, and also enables the lining to conform (at least to some degree) to shifts in the configuration of the mass of material due to time, or the environmental conditions to which the mass of material is exposed. Moreover, in earth filled dams, of the types shown in FIGS. 1-3, the resin saturated fabric reinforces the mass of material with high tensile strength, high tear resistance, and high puncture resistance. Moreover, the resin saturated fabric is capable of resisting structural loads, acts as a moisture and water barrier, and provides a way of creating a hydraulic barrier that can be used to resist formation of fissures and piping in earth filled dams

According to the present invention, the flexible lining may be embedded in the mass of material (FIGS. 2, 3), or the flexible lining may be disposed against a side of the mass of material (FIG. 1).

In addition, in a preferred embodiment, the flexible lining includes silica or similar particles in the resin to create friction between the flexible lining and the mass of material.

FIGS. 5 and 6 schematically illustrate other ways in which a lining can reinforce a mass of material, according to the principles of the present invention. For example, FIG. 5 schematically illustrates the use of lining sections 502 (each formed of fabric saturated with resin, as described above) for stabilizing the slope of a mass of material 500 against possible landslides. Such structure could be e.g. a mass of material in a mining environment, a landfill, a mountainside or hillside, etc. FIG. 6 schematically illustrates mechanically stabilized earth (MSE) walls 600, with a stabilizing lining comprising resin saturated fabric sections 602, each comprising fabric saturated with resin, as described above. The fabric can be one piece or multiple strips. When multiple layers of fabric as used, there may be a slip incorporated into the overall design of the reinforced material mass, so that if hydraulic or other pressures are placed on the mass of material, the slip will act to release the tension (strain). In each of FIG. 5 or 6, the lining is either embedded in the mass of material, or can applied against a side of the mass of material, as will be appreciated by those in the art. Drainage holes can be cut out of the fabric to allow drainage if needed.

Thus, as seen from the foregoing description, the present invention provides a fabric saturated with resin, which provides a mass of material with tensile strength, high tear resistance, and high puncture resistance. Moreover, the resin saturated fabric is capable of resisting structural loads, and acts as a moisture and water barrier. The present invention provides a way of creating a hydraulic barrier that can be used to resist formation of fissures and piping in earth filled dams, for slope stabilization, and for other applications such as mine tailing.

Thus, according to the foregoing description, applicant has provided a mass of material with a flexible lining that is particularly useful when the mass of material forms a dam or other comparable structure. While application of the principles of this invention to dams has been described above, it is contemplated that the principles of the present invention can also be applied to other types of material masses, that are used, e.g. for (i) mine tailing dams and ponds, (ii) levees and channels, (iii) animal waste retainage ponds, (iv) animal bed retention, (v) highway bed retention. With the foregoing disclosure in mind, it is believed that various adaptations of a mass of material with a flexible lining, according to the principles of the present invention, will be apparent to those in the art.

1. A reinforced material mass comprising a mass of material taken from a class that includes earthen material, soil, rock, and combinations thereof, with a lining forming a part thereof, the lining comprising a fabric saturated with a resin that has a flexibility of at least 3-6% elongation at break.

2. A reinforced material mass as defined in claim 1, wherein the lining is embedded in the mass of material.

3. A reinforced material mass as defined in claim 1, wherein the lining is disposed against a side of the mass of material.

4. A reinforced material mass as defined in claim 1, wherein the lining includes silica particles in the resin to create friction between the lining and the mass of material.

5. A method of reinforcing a mass of material taken from a class that includes earthen material, soil, rock, and combinations thereof, comprising combining the mass of material with a lining comprising a fabric saturated with a resin that has a flexibility of at least 3-6% elongation at break.

6. A method as defined in claim 5, including the step of embedding the lining in the mass of material.

7. A method as defined in claim 5, including the step of applying the lining against a side of the mass of material.

8. A method as defined in claim 5, wherein the lining includes silica particles in the resin to create friction between the lining and the mass of material.
